(19) United States
(12) Patent Application Publication
(10) Pub. No.: US 2008/0232599 A1
(43) Pub. Date: Sep. 25, 2008

(54) CONTENT DISTRIBUTING METHOD, COMPUTER-READABLE RECORDING MEDIUM RECORDED WITH PROGRAM FOR MAKING COMPUTER EXECUTE CONTENT DISTRIBUTING METHOD AND RELAY DEVICE

(75) Inventor: Yuichi TERUI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/042,686

(22) Filed: Mar. 5, 2008

(30) Foreign Application Priority Data
Mar. 19, 2007 (JP) JP2007-070504

(51) Int. Cl. H04L 9/08

(52) U.S. Cl. 380/283

(57) ABSTRACT

Content data is distributed by distributing enciphered content data from a higher (upper) distribution source through a relay node to a lower information processing device; obtaining a decoding key data for decoding by the lower information device content data associated with a viewing/listening area managed by the relay node; and distributing the decoding key data to the lower information processing device.

### CROSS-REFERENCE TO RELATED APPLICATIONS

This application is related to and claims priority to Japanese patent application no. 2007-70504 filed on Mar. 19, 2007 in the Japan Patent Office, and incorporated by reference herein.

### BACKGROUND

1. Field

The inventive embodiments relate to data distribution on a computer network.

2. Description of the Related Art

In connection with the shift from analog terrestrial broadcasting to digital terrestrial broadcasting, it has been required to take a prompt action for visually and audibly hard areas in which digital broadcasting waves are hard to reach and/or for which it is too late to provide equipment adapted to the digital terrestrial broadcasting.

Therefore, there has been proposed a distributing method of distributing the digital terrestrial broadcasting to respective homes through the Internet by using IP networks. According to this distributing method, digital terrestrial broadcasting programs broadcasted from respective broadcast stations can be distributed to respective homes in visually and audibly hard areas by using existing infrastructure equipment.

Furthermore, there has been proposed a distributing method for distributing digital terrestrial broadcasting programs to respective homes in visually and audibly hard areas by using a distributing service for distributing video contents to specific users.

For example, digital terrestrial broadcasting programs can be distributed to respective homes in visually and audibly hard areas by using distributing services containing telecommunications carriers as cores, which is called as a triple play. This is a service for providing plural services (Internet connection, IP telephone, video distribution) through one line by applying a multiple-wavelength technique to a single mode fiber.

Furthermore, digital terrestrial broadcasting programs can be distributed to respective homes in visually and audibly hard areas by using a distribution service for immediately distributing video information required by each user, which is called as VOD (Video On Demand). This is a service for establishing one-to-one communication session between a communication carrier and a user and transmit/receive a video content therebetween.

If it is possible for each user to connect to the Internet, the user can be supplied with the distribution service of digital terrestrial broadcasting programs at any place. In this case, it is impossible to secure area limitation, that is, it is impossible to limit a distribution service to a special area, so that it is impossible to establish a business model for local broadcast stations which are dependent on local CM income.

In this case, the digital terrestrial broadcasting programs are also randomly distributed using the IP networks, and thus there is a risk that a malignant third party falsifies a program content or the like during the distribution of the program content.

Furthermore, when the triple play is used, a distribution/charging system is a dedicated service which is different among communications carriers, and information as to which user views/listens to which program is collected by communication carriers, so that it is difficult to keep anonymity of viewing/listening of broadcasting.

In the case of use of VOD, a unicast communication in which a single address is addressed to transmit data to a specific partner is carried out. Therefore, when a digital terrestrial broadcast program is handled, handling of copyrights is remarkably cumbersome. Furthermore, the network band is put under compression in principle, so that it is improper to apply this technique to broadcasting.

Furthermore, by using a method of rightly transmitting a work key for decoding a scramble key of a program content to be re-transmitted (re-broadcasted) to a user who makes a contract with a re-transmitting (re-broadcasting) business organization such as a cable television business organization or the like, only a person who makes a contract by deed can view/listen to a program content through a re-transmitting (re-broadcasting) business organization (for example, JP-A-2002-281477), and digital terrestrial broadcasting programs can be distributed to respective homes in visually and audibly hard areas.

This method is based on such a mechanism that a decoding key for decoding an enciphered content is distributed to a user who makes a contract with a communication carrier, so that it is very difficult to apply this technique to a service for providing broadcast contents such as digital terrestrial broadcasting programs, etc. to general audiences. This is because it is necessary to construct one-to-one infrastructure facilities between a communication carrier and a contractant and thus tremendous business investment and working time must be required to construct the infrastructure equipment with all audiences who view/listen to the broadcast contents, so that the operating cost of the service is increased.

### SUMMARY

According to an aspect of an embodiment, a content data distributing method is provided by distributing enciphered content data from a higher (upper) distribution source through a relay node to a lower information processing device; obtaining by the relay node (for example, without limitation, out of/from the enciphered content data) a decoding key data for decoding, which is to be executed in an information processing device lower than the relay node, content data associated with a viewing/listening area managed by the relay node; and distributing the obtained decoding key data to the information processing device lower than the relay node.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1A is a diagram showing the system construction of a communication system according to an embodiment;

FIG. 1B is a diagram showing a content distribution service;

FIG. 2 is a diagram showing a storage content of a group information DB;

FIG. 3 is a diagram showing the hardware construction of a computer device shown in FIG. 1A;

FIG. 4 is a block diagram showing the functional construction of the communication system according to the embodiment;

FIG. 5 is a diagram showing encoding processing based on RPS code;

FIG. 6A is a sequence diagram showing a decoding key data distribution processing procedure of the communication system of the embodiment;

FIG. 6B is a sequence diagram showing the content distribution processing procedure of the communication system according to the embodiment;

FIG. 7 is a diagram (part 1) showing an example of an enciphering system;

FIG. 8 is a diagram showing a detailed system construction of the communication system according to an embodiment 2;

FIG. 9 is a sequence diagram showing data communication processing of the embodiment 2;

FIG. 10 is a diagram showing the detailed system construction of the communication system according to an embodiment 3;

FIG. 11 is a sequence diagram showing the data communication processing of the embodiment 3; and

FIG. 12 is a diagram (part 2) showing an example of the enciphering system.

### DETAILED DESCRIPTION OF THE PREFERRED EMBODIMENTS

(System Construction of Communication System)

First, the system construction of the communication system according to a first embodiment will be described.

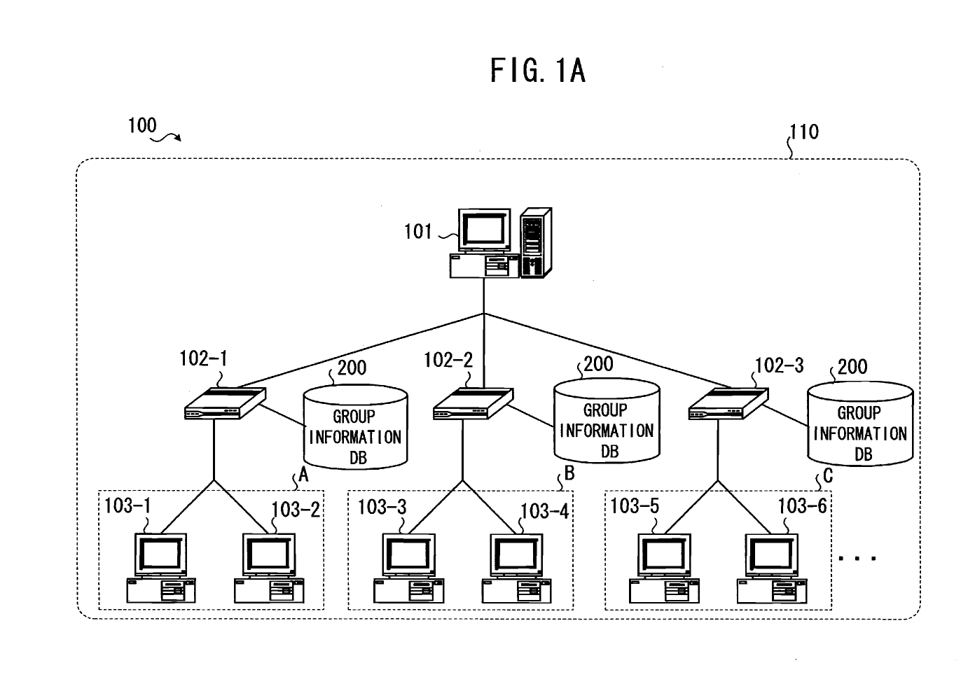

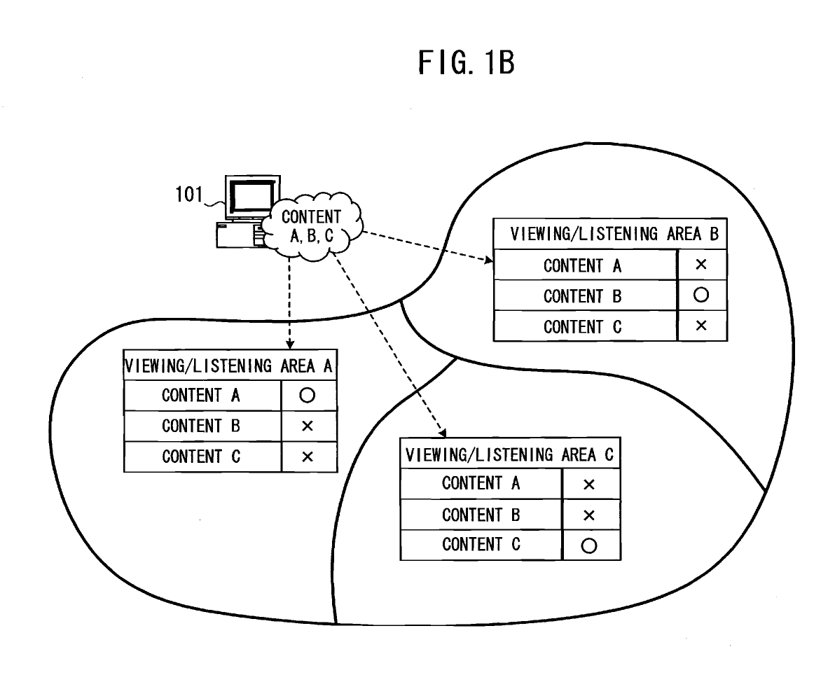

FIG. 1A is a diagram showing the system construction of the communication system according to the embodiment. In FIG. 1A, the communication system 100 includes a content distributing device 101, plural relay nodes 102-1 to 102-3 (three relay nodes in FIG. 1A) and plural information processing devices 103-1 to 103-6 (six devices in FIG. 1A) which are connected to one another through a network 110.

The content distributing device 101 is a computer device having a function of distributing content data such as digital terrestrial broadcasting programs, etc. broadcasted from broadcast stations. The content data are associated with respective viewing/listening areas A to C (three areas in FIG. 1A).

Each of the relay nodes 102-1 to 102-3 is a computer device having a function of relaying content data distributed from the content distributing device 101 to the information processing device 103. The relay node 102-1 to 102-3 has a group information database (DB) 200, and also has a function of distributing a decoding key data for decoding enciphered content data to a lower information processing device 103 which is lower than the relay node concerned.

The information processing device 103-1 to 103-6 is a computer device used by an audience in each of the viewing/listening areas A to C, and has a function of receiving content data distributed from the content distributing device 101. Furthermore, the information processing device 103-1 to 103-6 has a function of receiving decoding key data for decoding the content data associated with the viewing/listening area to which the device concerned belongs, from the relay node 102 for managing the viewing/listening area concerned.

Here, the general outline of the content distribution service will be described. FIG. 1B is a diagram showing the general outline of the content distribution service. In FIG. 1B, the content distributing device 101 multicast-distributes enciphered content data A to C to all the information processing devices 103-1 to 103-6 (see FIG. 1A) in the viewing/listening areasAto C.

Therefore, the content data A to C are distributed to all the information processing devices 103-1 to 103-6 in the viewing/listening areas A to C. Furthermore, in the communication system 100, the decoding key data for decoding the content data associated with each of the viewing/listening areas A to C is distributed to only the information processing devices 103-1 to 103-6 in the respective viewing/listening areas A to C.

For example, an example of the content data A will be described. The decoding key data for decoding the content data A is distributed to only the information processing devices 103-1 and 103-2 in the viewing/listening area A. Therefore, the content data A cannot be decoded in the information processing devices 103-3 to 103-6 in the viewing/listening areas B and C.

(Storage Content of Group Information DB 200)

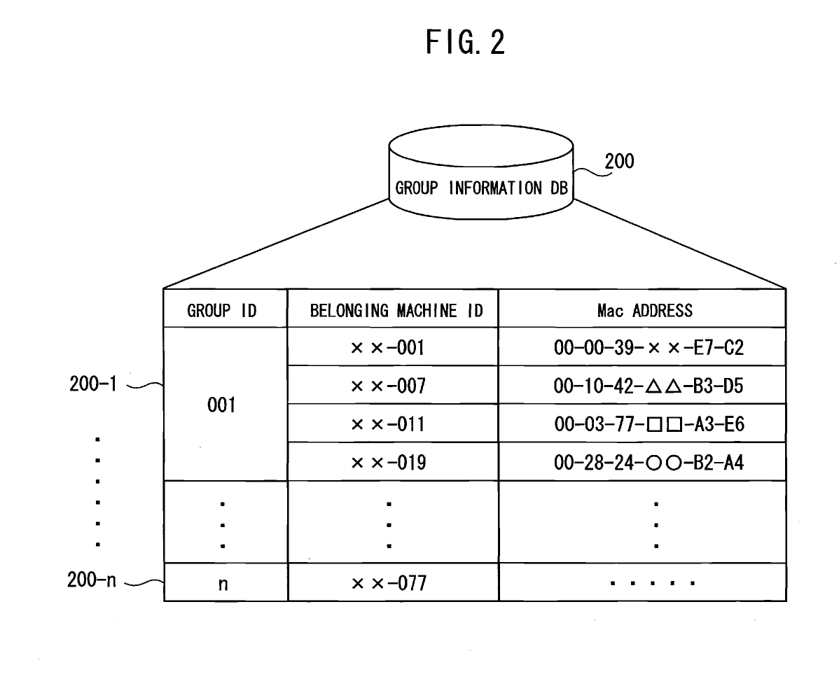

Next, the group information DB 200 will be described. FIG. 2 is a diagram showing the storage content of the group information DB 200. In FIG. 2, the group information DB 200 holds group information 200-1 to 200-n concerning group IDs, belonging machine identifiers (IDs) and Media Access Control (Mac) addresses for every group.

The group represents a logical link and has a transmission function which is the same level as the physical link. A plurality of groups is allowed to be constructed in one physical link, whereby plural Mac addresses are provided in one physical port and a link is established between the relay node 102 and the information processing device 103 for every group.

The group ID is identification information allocated to each group. The belonging machine ID is identification information allocated to each belonging machine (the relay node 102 and the information processing device 103) in the group. Furthermore, the Mac address is an address inherently allocated to each belonging machine. Each of the relay nodes 102-1 to 102-3 can identify the address of the decoding key data on the basis of the combination of the belonging machine ID and the Mac address in the group.

(Hardware Construction of Computer Device)

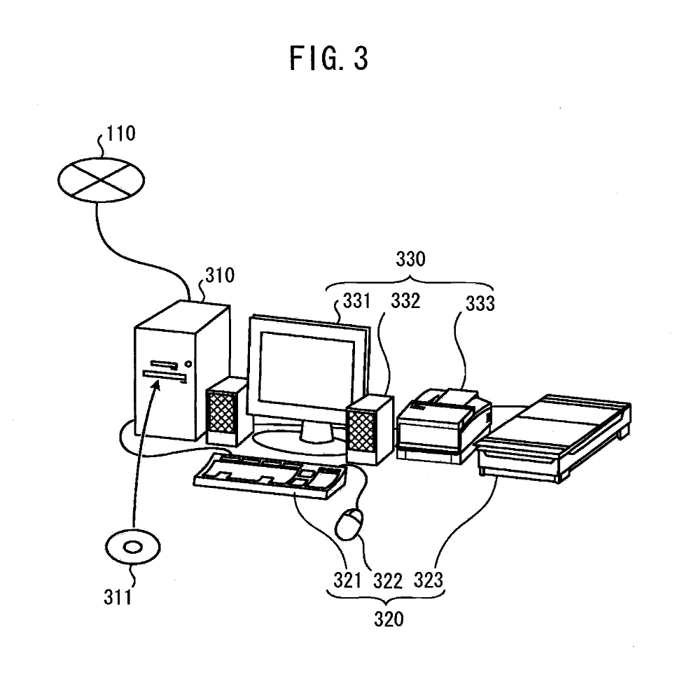

Next, the hardware construction of the computer device shown in FIG. 1A will be described. FIG. 3 is a diagram showing the hardware construction of the computer device shown in FIG. 1A. In FIG. 3, the computer device is constructed by a computer main body 310, an input device 320 and an output device 330, and it is connectable to a network 110 such as LAN, WAN, the Internet or the like through a router or a modem (not shown).

The computer main body 310 has CPU, a memory and an interface. CPU performs the overall control of the hardware construction of the computer device, etc. The memory is constructed by ROM, RAM, HD, an optical disc 311 and a flash memory. The memory is used as a work area of CPU.

Furthermore, various kinds of programs are stored in the memory, and these programs are loaded in response to a command from CPU. Data reading and writing of HD and the optical disc 311 are controlled by a disc drive. The optical disc 311 and the flash memory are freely detachably mounted in the computer main body 310. The interface controls the input from the input device 320, the output to the output device 330 and the transmission/reception to/from the network 110.

Furthermore, the input device 320 may contain a keyboard 321, a mouse 322, a scanner 323 or the like. The keyboard 321 has keys for inputting characters, numerical characters, various kinds of instructions, etc. to input data, and it may be designed as a touch panel type. The mouse 322 shifts a cursor, selects a range, moves a window, changes the size of the window, etc. The scanner 323 optically reads an image. The read-out image is taken in as image data, and stored into the memory in the computer main body 310. The scanner 323 may be provided with an OCR function.

The output device 330 may contain a display 331, a speaker 332, a printer 333 or the like. The display 331 displays not only a cursor, icons and a tool box, but also data such as documents, images, function information, etc. Furthermore, the speaker 332 outputs sounds such as sound effects, reading sounds, etc. Furthermore, the printer 333 prints image data and document data.

(Functional Construction of Communication System 100)

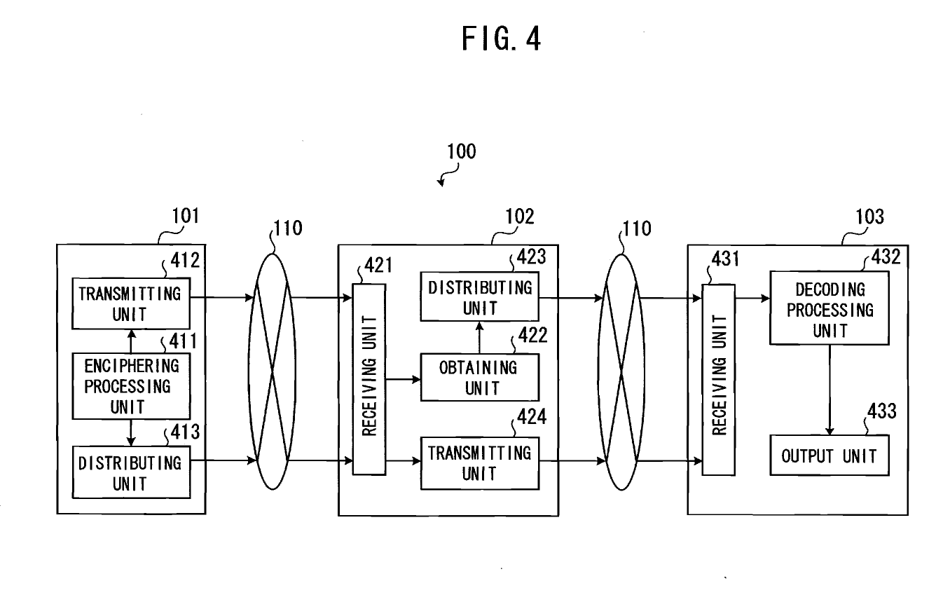

Next, the functional construction of the communication system 100 according to this embodiment will be described. FIG. 4 is a block diagram showing the functional construction of the communication system 100 according to this embodiment. In FIG. 4, the communication system 100 is constructed by a content distributing device 101, a relay node 102 and an information processing device 103.

The content distributing device 101 is constructed by an enciphering processing unit 411, a transmitting unit 412 and a distributing unit 413. The relay node 102 is constructed by a receiving unit 421, an obtaining unit 422, a distributing unit 423 and a transmitting unit 424. The information processing unit 103 is constructed by a receiving unit 431, a decoding processing unit 432 and an output unit 433.

These functions 411 to 413, 421 to 424 and 431 to 433 can be implemented by making CPU execute programs concerning the functions concerned which are stored in the memory. Furthermore, the output data from the respective functions 411 to 413, 421 to 424, 431 to 433 are held in the memory. The functional construction of the connection destination indicated by arrows in FIG. 4 reads out the output data from the function of the connection source from the memory and makes CPU to execute the program concerning the function concerned.

First, the respective functions 411 to 413 of the content distributing device 101 will be described.

The enciphering processing unit 411 has a function of executing encoding and/or enciphering processing on content data and storing the processing result into the memory. The content data is a broadcasting content such as a movie, a drama, a news, a sports program, a commercial or the like which is broadcasted in the digital terrestrial broadcast.

Furthermore, the content data is associated with each viewing/listening area which is obtained by sectioning the area in the communication system 100 under a predetermined condition. The condition for sectioning the viewing/listening area is arbitrarily set by an operator of the communication system 100 or the like, and for example, it may be sectioned by every prefecture or every municipality.

In general, broadcast contents can be sectioned into broadcast contents for nationwide broadcast and broadcast contents for some locally limited broadcast contents. Particularly, news, sport programs, commercials, etc. are broadcast contents having higher regional characteristics, and normally these locally limited broadcast contents are broadcasted from broadcast stations in respective local areas so that they can be viewed/listened within some local areas.

In this case, in consideration of the area limited characteristic of the broadcast contents, each content data is associated with each viewing/listening area in the communication system 100. For example, when the viewing/listening area is sectioned for every prefecture, content data concerning a sports program of a baseball team based in Hiroshima prefecture is associated with Hiroshima prefecture, and content data concerning a commercial message of a business enterprise which supplies services mainly in Kyoto-fu is associated with Kyoto-fu.

The content data may be directly input to the content distributing device 101, or obtained from an external device through the network 110. For example, digital terrestrial broadcast waves broadcasted from a broadcast station in each local area may be received, and the digital terrestrial broadcast information thereof may be obtained as content data.

Here, an example of the encoding processing of the enciphering processing unit 411 will be described. In general, the efficiency of data communication is enhanced by encoding and transmitting content data. In this case, the encoding processing for encoding content data by using an error-correcting code having a variable encoding rate will be described. RPS (Random Parity Stream) code may be used as the error-correcting code having the variable encoding rate (see Japanese Patent Application No. 2004-539446).

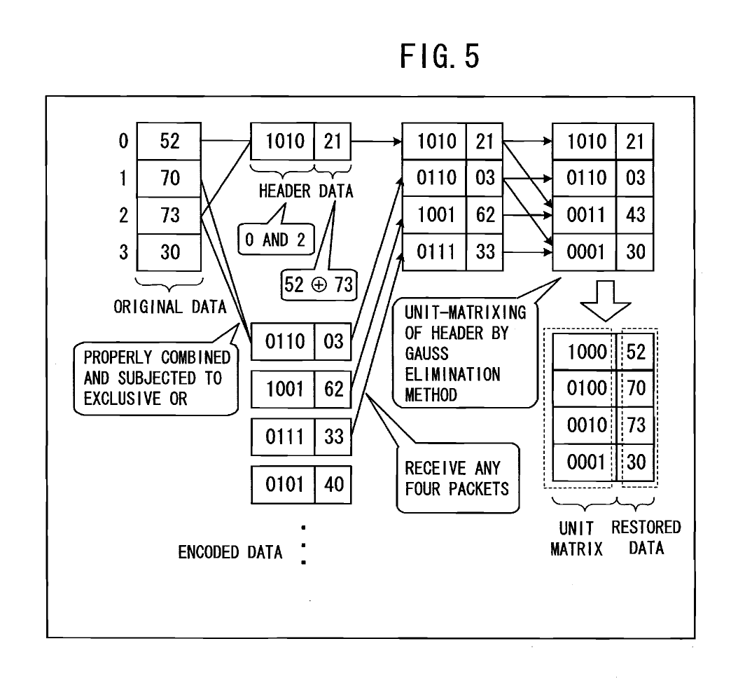

FIG. 5 is a diagram showing the general outline of the encoding processing based on the RPS code. In FIG. 5, first, original data [R(0x52), p(0x70), s(0x73), 0(0x30)] are divided into plural blocks, and exclusive OR (XOR) operation is executed between the blocks [52, 73]. Then, the operation result is added with header information in which the XOR-operated block is set to “1” and the remaining blocks are set to “0”, thereby generating encoded data.

A device for receiving this encoded data (for example, the information processing device 103) applies the Gauss elimination method to the header information of the encoded data, thereby obtaining the original data. According to the encoding system based on the RPS code, by generating encoded data whose data amount is excessive by several percentages, plain text data can be restored from an inverse matrix of the header information even when a part of the encoded data disappears.

Furthermore, in the RPS code, tolerance to the disappearance of encoded data can be varied by changing the number of encoded data to be generated or the length (code length) of a bit array used for encoding. The encoded data (content data) can be efficiently transmitted by properly changing the tolerance in accordance with the rate of disappearance of the encoded data.

The enciphering processing unit 411 can also execute enciphering processing using various kinds of enciphering methods on the content data which are subjected to the encoding processing. In this case, any enciphering method may be used insofar as it prevents a third party from peeping at or dishonestly altering the communication content at some midpoint of the communication. For example, an enciphering method such as RSA, ElGamal or the like may be used. The description of the enciphering processing using various kinds of enciphering systems is omitted because it is a well-known technique.

The transmitting unit 412 has a function of transmitting decoding key data for decoding content data enciphered by the enciphering processing unit 411 to the relay node 102 for managing the viewing/listening area associated with the content data concerned.

Specifically, for example, the transmitting unit 412 specifies the relay node 102 for managing the viewing/listening area associated with the content data on the basis of information for specifying the relay node 102 for managing each viewing/listening area, and establishes a session with the relay node 102 concerned, thereby transmitting the decoding key data. The information for specifying the relay node 102 for managing each viewing/listening area may be stored in the memory in advance, and/or may be directly input to the content distributing device 101.

The decoding key data is a decoding key corresponding to an enciphering key used for the enciphering processing of the enciphering processing unit 411, and it may be generated in time with the enciphering processing of the content data. Furthermore, it may be issued together with the enciphering key from a reliable certification organization. In this case, the enciphering processing unit 411 enciphers the content data by using the enciphering key issued from the certification organization.

The distributing unit 413 has a function of reading out the content data enciphered by the enciphering processing unit 411 from the memory, and transmitting the enciphered content data through the relay node 102 to the information processing device 103. Specifically, for example, the distributing unit 413 multicast-distributes the enciphered content data to all the information processing devices 103 in the communication system 100 through the network 110 such as an IP network.

Next, each of the functions 421 to 424 of the relay node 102 will be described.

The receiving unit 421 has a function of receiving the decoding key data transmitted from the content distributing device 101 and storing the decoding key data into the memory. Furthermore, the receiving unit 421 has a function of receiving the content data distributed from the content distributing device 101 and storing the content data into the memory.

The obtaining unit 422 has a function of obtaining decoding key data for decoding, the decoding executed in a lower information processing device 103 than the self node, content data which are associated with a viewing/listening area managed by the node of the obtaining unit 422 (hereinafter referred to as “self node”) and contained in the content data distributed from the content distributing device 101, and storing the decoding key data into the memory.

Specifically, when the decoding key data is received by the receiving unit 421, the obtaining unit 422 reads out the decoding key data from the memory to thereby obtain the decoding key data concerned. Furthermore, the obtaining unit 422 may obtain decoding key data from a reliable certification organization. Still furthermore, when the enciphering key for enciphering the content data associated with the viewing/listening area is changed, the obtaining unit 422 obtains the decoding key data corresponding to the changed enciphering key in each case.

The distributing unit 423 has a function of reading out the decoding key data obtained by the obtaining unit 422 from the memory, and distributing the decoding key data to a lower information processing device 103 which is lower than the self node. Specifically, the decoding key data is distributed to the information processing device 103 in lower layers (first layer to fourth layer) in the OSI (Open Systems Interconnection) reference model. For example, the decoding key data may be distributed to the information processing device 103 by using a LAN system, such as ETHERNET implemented by a physical layer comprising a first layer and a second layer and a data link layer in the OSI reference model.

More specifically, the distributing unit 423 distributes the decoding key data to an information processing device 103 lower than the self node on the basis of the information specifying the viewing/listening area and the information identifying the information processing device 103 existing in the viewing/listening area concerned. The viewing/listening area corresponds to the group shown in FIG. 2, and the information specifying the viewing/listening area corresponds to the group ID.

For example, the distributing unit 423 specifies the information processing device 103 forming a group with the self node on the basis of the storage content of the group information DB 200, and distributes the decoding key data to the information processing device 103 concerned. Accordingly, even when there exist plural viewing/listening areas to be managed by the self node, that is, plural groups containing the self node exist, the information processing device 103 as a distribution destination can be specified.

Furthermore, the distributing unit 423 may transmit the decoding key data to the lower information processing device 103 than the self node on the basis of information specifying a relay node group interposed between the self node and the information processing device 103 existing in the viewing/listening area.

For example, the information specifying the node group in the group is added on the basis of the storage content of the group information DB 200 and then the decoding key data is distributed, whereby the decoding key data can be distributed along the transmission path formed by the node group. Accordingly, when the viewing/listening area where the information processing device 103 in the group is located is shifted to another viewing/listening area, the decoding key data can be prevented from being distributed to the information processing device 103 concerned.

The transmitting unit 424 has a function of transmitting the enciphered content data distributed from the higher content distributing device 101 to the lower information processing device 103 than the self node. Specifically, the transmitting unit 424 reads out from the memory the content data received by the receiving unit 421, and transmits the content data concerned to another the relay node 102 and/or the information processing device 103 which is directly connected to the self node and lower than the self node concerned.

Furthermore, the distributing unit 423 may distribute the decoding key data to the lower information processing device 103 than the self node prior to the relay of the content data associated with the viewing/listening area managed by the self node. That is, the decoding key data is distributed to the information processing device 103 by the distributing unit 423 before the content data associated with the viewing/listening area managed by the self node is transmitted to the lower information processing device 103 by the transmitting unit 424.

Next, each of the functions 431 to 433 of the information processing device 103 will be described. The receiving unit 431 has a function of receiving the decoding key data distributed from the relay node 102 and storing it into the memory. Furthermore, the receiving unit 431 has a function of receiving the content data distributed from the relay node 102 and storing it into the memory.

By using the decoding key data received by the receiving unit 431, the decoding processing unit 432 decodes the content data associated with the viewing/listening area to which the device body belongs, and stores the decoded content data into the memory. Various content data associated with viewing/listening areas in respective regions are distributed to the information processing device 103.

By using the decoding key data distributed from the higher relay node 102, the decoding processing unit 432 decodes the content data associated with the viewing/listening area to which the device body belongs. The description on the decoding processing of the decoding processing unit 432 is omitted because it is a well-known technique.

The output unit 433 has a function of reading out the content data decoded by the decoding processing unit 432 from the memory and outputting the read-out content data. Specifically, for example, the output unit 433 outputs the decoded content data to an information output device (television reproducing device or the like) connected to the information processing device 103.

(Data Communication Processing of Communication System 100)

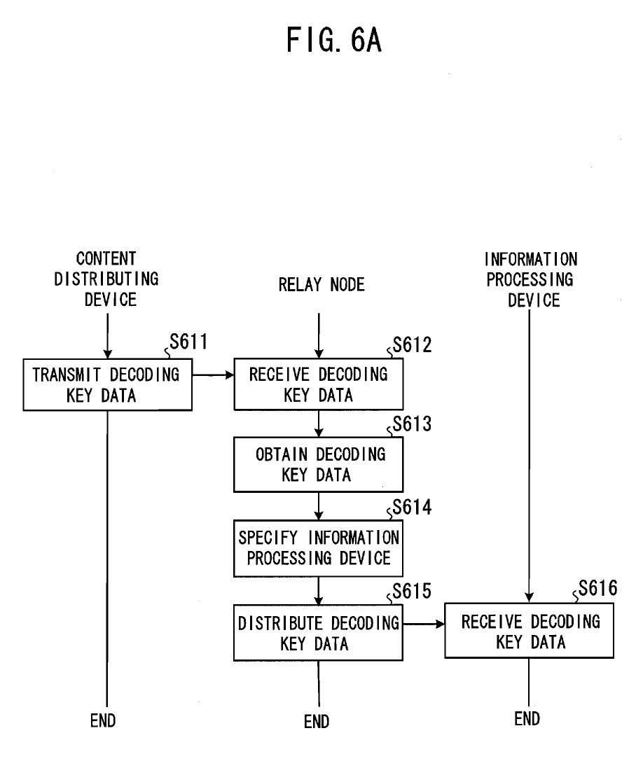

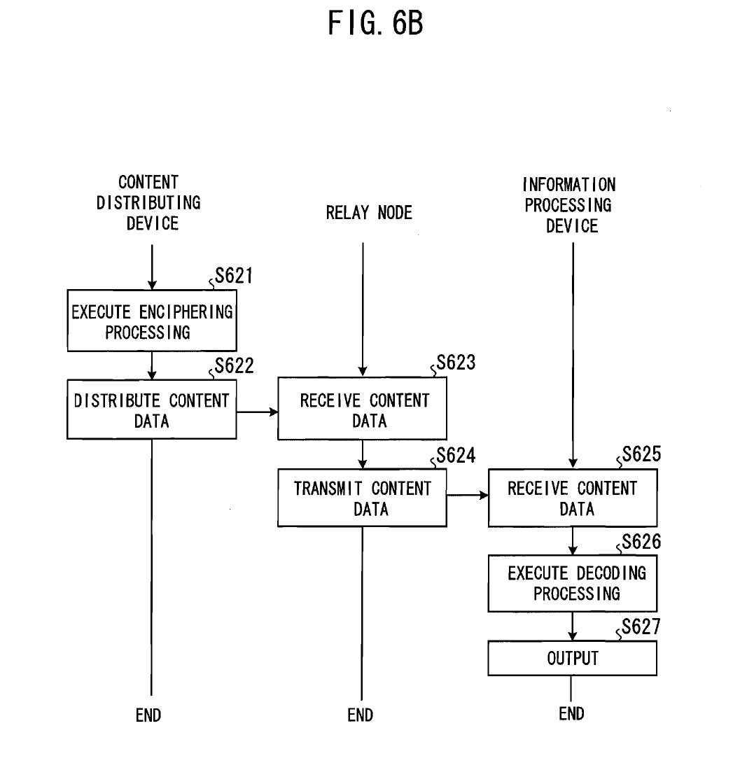

Next, the data communication processing of the communication system 100 according to this embodiment will be described. First, the decoding key data distribution processing procedure of the communication system 100 will be described. FIG. 6A is a sequence diagram showing the decoding key data distributing processing procedure of the communication system 100 according to this embodiment. In this case, the decoding key data distributing processing procedure for distributing the decoding key data for decoding the content data associated with a viewing/listening area N will be described.

In FIG. 6A, the decoding key data for decoding the content data associated with the viewing/listening area N is first transmitted to the relay node 102 for managing the viewing/listening area N by the transmitting unit 412 of the content distributing device 101 (S611).

Thereafter, the decoding key data associated with the viewing/listening area N managed by the self node is received by the receiving unit 421 of the relay node 102 for managing the viewing/listening area N (S612), and the decoding key data received by the receiving unit 421 is obtained by the obtaining unit 422 (S613).

Thereafter, on the basis of the storage content of the group information DB 200, the distributing unit 423 specifies the lower information processing device 103 than the self node (S614), and distributes the decoding key data obtained by the obtaining unit 422 to the lower information processing device 103 than the self node (S615). Then, the receiving unit 431 of the information processing device 103 receives the decoding key data for decoding the content data associated with the viewing/listening area N to which the device body belongs (S616).

Next, the content distributing processing procedure of the communication system 100 will be described. FIG. 6B is a sequence diagram showing the content distributing processing procedure of the communication system 100 according to this embodiment. In FIG. 6B, the enciphering processing unit 411 of the content distributing device 101 first executes the enciphering processing on the content data to be distributed (S621).

Thereafter, the distributing unit 413 multicast-distributes the content data enciphered in S621 to all the information processing devices 103 in the communication system 100 (S622). Subsequently, the receiving unit 421 of the relay node 102 receives the enciphered content data (S623), and the transmitting unit 424 transmits the enciphered content data to the lower information processing device 103 than the self node (S624).

Thereafter, the receiving unit 431 of the information processing device 103 receives the enciphered content data (S625). Subsequently, by using the decoding key data received in S616 shown in FIG. 6A, the decoding processing unit 432 executes the decoding processing of decoding the content data which are associated with the viewing/listening area to which the device body belongs and contained in the content data received by the receiving unit 431 (S626), and outputs the decoded content data (S627).

As described above, according to the embodiment of the present invention, in the content distributing service for multicast-distributing enciphered content data to plural information processing devices 103, the decoding key data for decoding the content data associated with each viewing/listening area can be distributed to the information processing devices 103 in the corresponding viewing/listening area.

Accordingly, in the content distributing service using the IP network, the locally limited property of each content data can be properly maintained. Specifically, for example, the decoding key data for decoding the enciphered digital terrestrial broadcasting content is distributed to only the corresponding viewing/listening area, whereby the local limitation of the digital terrestrial broadcast can be maintained.

### Embodiment 2

Next, an embodiment 2 of the communication system 100 will be described.

In the embodiment 2, a video content encoded by using the RPS code is distributed. Specifically, header information of an encoded video content is subjected to scramble processing and then distributed, and scramble information concerning the header information is limited and distributed to a specific area as a decoding key.

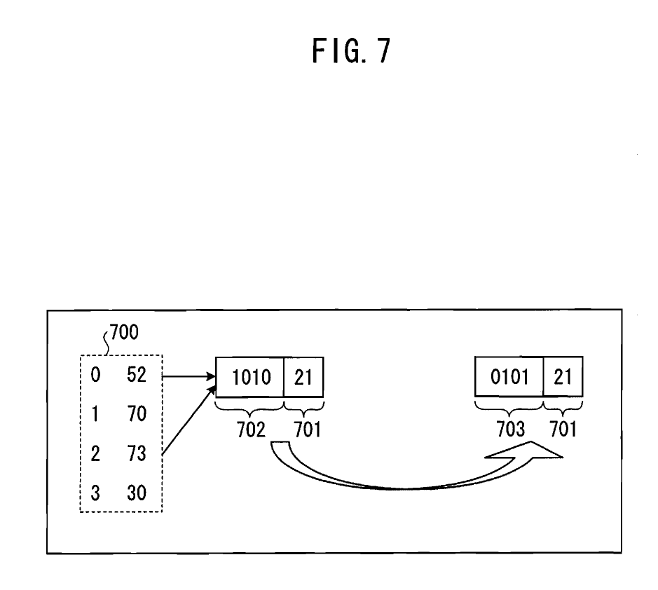

First, it is assumed that an enciphering system of a video content in the embodiment 2 will be described. In this case, original data is [R(0x52), p(0x70), s(0x73), O(0x30) and encoded by using the RPS code. FIG. 7 is a diagram (part 1) showing an example of the enciphering system.

In FIG. 7, the original data 700 is divided into four blocks [52, 70, 73, 30]. Data 701 represents exclusive OR (XOR) between the blocks [52, 73], and data 702 is header information with which blocks which are subjected to exclusive OR (XOR) are represented by “1” and the residual blocks are represented by “0”. Data 703 is header information after conversion which is obtained by subjecting the data 702 to the scramble processing.

In the embodiment 2, by distributing the data 702 while subjecting the data 702 to the scramble processing, the confidence of the video content is secured, and the video content is re-constructed by using a distributed decoding key (scramble information). The scramble information is a conversion table representing the conversion from the data 702 to the data 703, for example.

Furthermore, in the foregoing description, the bit length of the header information is set to 4 bits. However, the scramble effect can be enhanced by setting the bit length to 32, 64, 128, 256, 512, 1024, etc.

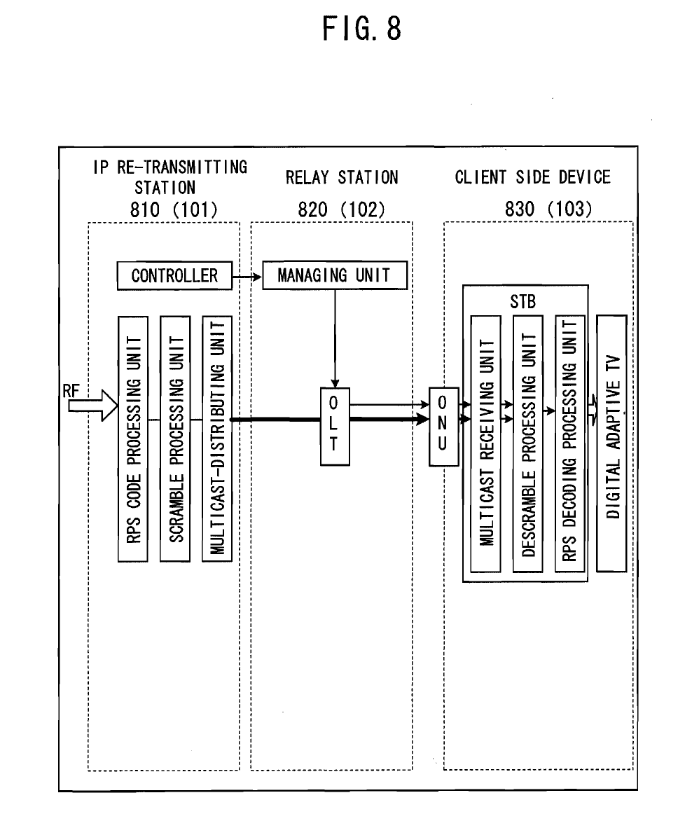

Next, the detailed system construction of the communication system 100 of the embodiment 2 will be described. FIG. 8 is a diagram showing the detailed system construction of the communication system 100 according to the embodiment 2. In FIG. 8, the communication system 100 is constructed by an IP re-transmitting station 810 (101), a relay station 820 (102) and a client side device 830 (103). In FIG. 8, Radio Frequency (RF) represents digital terrestrial broadcasting radio waves.

The IP re-transmitting station 810 is equipped with a broadcasting antenna (not shown) for receiving a digital terrestrial broadcast wave broadcasted from a broadcast station, and multicast-distributes the video content based on the digital terrestrial broadcast wave concerned to the client side device 830. The IP re-transmitting station 810 can be implemented by the content distributing device 101 shown in FIG. 4, for example.

The relay station 820 relays the video content distributed from the IP re-transmitting station 810, and transmits the video content to the client side device 830. Furthermore, the relay station 820 transmits the decoding key for decoding the enciphered video content to the client side device 830. The relay station 820 can be implemented by the relay node 102 shown in FIG. 4.

The client side device 830 is a user's computer device which is supplied with a video content distributing service. In this case, the client side device 830 belongs to the viewing/listening area N, and this will be described by exemplifying a case where the video content associated with the viewing/listening area N is distributed from the IP re-transmitting station 810.

Next, a module constructing the communication system 100 will be described. In FIG. 8, the controller is a module of the IP re-transmitting station 810, and controls the IP re-transmitting station 810. Furthermore, the controller has a function of controlling a communication interface (not shown) to transmit the decoding key for decoding the video content to the relay station 820 for managing the viewing/listening area N.

The RPS code processing unit is a module of the P re-transmitting station 810, and executes the RPS code processing on the video content based on the digital terrestrial broadcast wave received by the broadcast antenna. The scramble processing unit is a module of the IP re-transmitting station 810, and executes the scramble processing on the video content encoded by the RPS code processing unit. The multicast-distributing unit is a module of the IP re-transmitting station 810, and distributes to the client side device 830 the video content N which is subjected to the scramble processing by the scramble processing unit.

The managing unit is a module of the relay station 820, and monitors and controls an optical line terminal OLT described later. Specifically, for example, it controls the optical line terminal OLT on the basis of the group information DB 200 shown in FIG. 2, and transmits the decoding key data transmitted from the controller of the IP re-transmitting station 810 to the optical network unit ONU of the client side device 830 described later.

The optical line terminal OLT is a module of the relay station 820, relays the video content distributed from the multicast distributing unit of the IP re-transmitting station 810, and transmits the video content to the optical network unit ONU of the client side device 830. Furthermore, the optical line terminal OLT transmits the decoding key data to the optical network unit ONU according to the control of the managing unit.

Specifically, the optical line terminal OLT transmits the decoding key data for decoding by the client device the video content associated with the viewing/listening area N to the optical network unit ONU of the client side device 830 according to the control of the managing unit.

The optical network unit ONU is a module of the client side device 830, and filters the video content and the decoding key transmitted from the optical line terminal OLT of the relay station 820. The set top box STB is a module of the client side device 830, and it comprises a multicast receiving unit, a descramble processing unit and an RPS decoding processing unit.

The multicast receiving unit receives the video content and the decoding key which are filtered by the optical network unit ONU. The descramble processing unit executes the descramble processing on the video content received by the multicast receiving unit by using the decoding key received by the multicast receiving unit.

The RPS decoding processing unit executes the RPS decoding processing on the video content descrambled by the descramble processing unit by using the decoding key. The digital adaptive TV is a module of the client side device 830, and outputs the video content decoded by the RPS decoding processing.

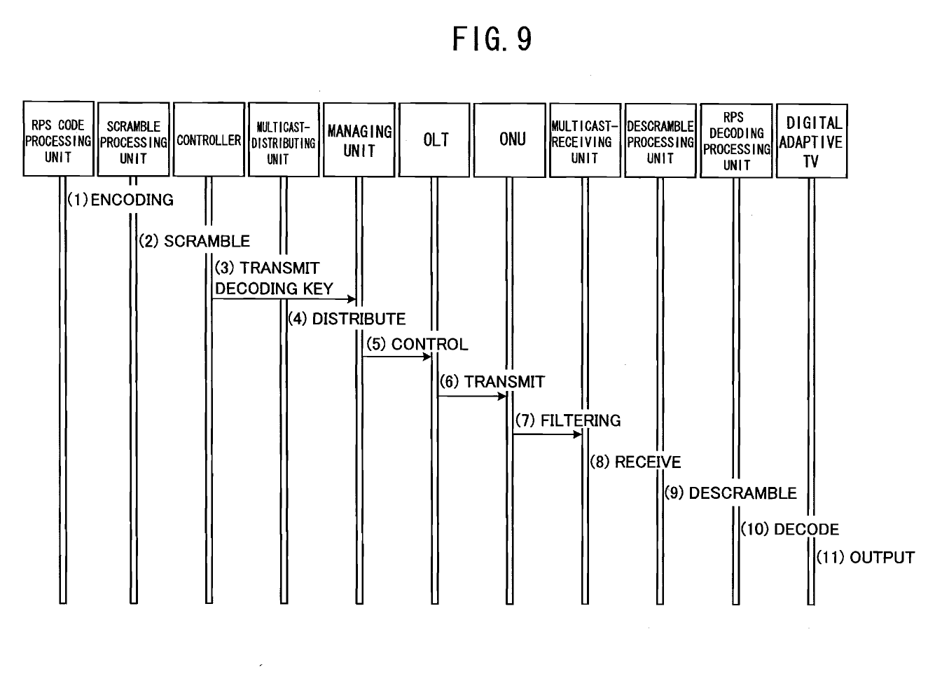

Next, the data communication processing of the embodiment 2 will be described. FIG. 9 is a sequence diagram showing the data communication processing of the embodiment 2. In the example shown in FIG. 9, a typical operation sequence concerning the distribution of the video content is shown. Numerical characters in parentheses represent the sequence order.

In FIG. 9, first, the RPS code processing unit of the IP re-transmitting unit 810 executes the RPS code processing on the video content based on the digital terrestrial broadcasting wave received by the broadcast antenna (1), and the scramble processing unit executes the scramble processing on the video content which is subjected to RPS encoding (2).

Thereafter, the controller transmits to the managing unit of the relay station 820 the decoding key data for decoding the video content which is subjected to the scramble processing (3). Furthermore, the multicast distributing unit distributes to the client side device 830 the video content which is subjected to the RPS code processing and the scramble processing (4).

Subsequently, OLT distributes the decoding key data to ONU according to the control of the managing unit by OLT, and also it relays the video content distributed from the IP re-transmitting station 810 and transmits it to the client side device 830 (6). Then, ONU filters the video content and the decoding key data transmitted from OLT (7), and passes them therethrough when they are addressed to the optical network unit ONU itself.

Subsequently, the multicast receiving unit receives the video content and the decoding key data which are subjected to filtering by ONU (8). Thereafter, the descramble processing unit descrambles the video content by using the decoding key data received by the multicast receiving unit (9), the RPS decoding processing unit decodes the video content (10), and finally the digital adaptive TV outputs the video content (11).

According to the embodiment 2, the mechanism of the re-transmitting system which practically uses the multicast distribution of the video content through the IP network can be provided, and the distribution service of digital terrestrial broadcasting programs which covers viewing/listening hard areas of digital terrestrial broadcast can be implemented.

Furthermore, the area limitation performance of broadcast contents which is indispensable for broadcast can be properly maintained. Still furthermore, by using the RPS code as the error correcting code, the confidence of video contents and the error correction can be implemented. Accordingly, the data communication speed can be increased, stability and communication quality can be enhanced, and the total cost of the communication system 100 can be implemented.

### Embodiment 3

Next, an embodiment 3 of the communication system 100 will be described. The same parts as described with respect to the embodiment 2 are represented by the same reference numerals, and the description thereof is omitted. In the embodiment 3, a video content encoded by using the RPS code is dispersively distributed. Specifically, the encoded video content is dispersed to plural dispersive data, and then these dispersive data are distributed. Furthermore, distribution information of these plural dispersive data is distributed as a decoding key.

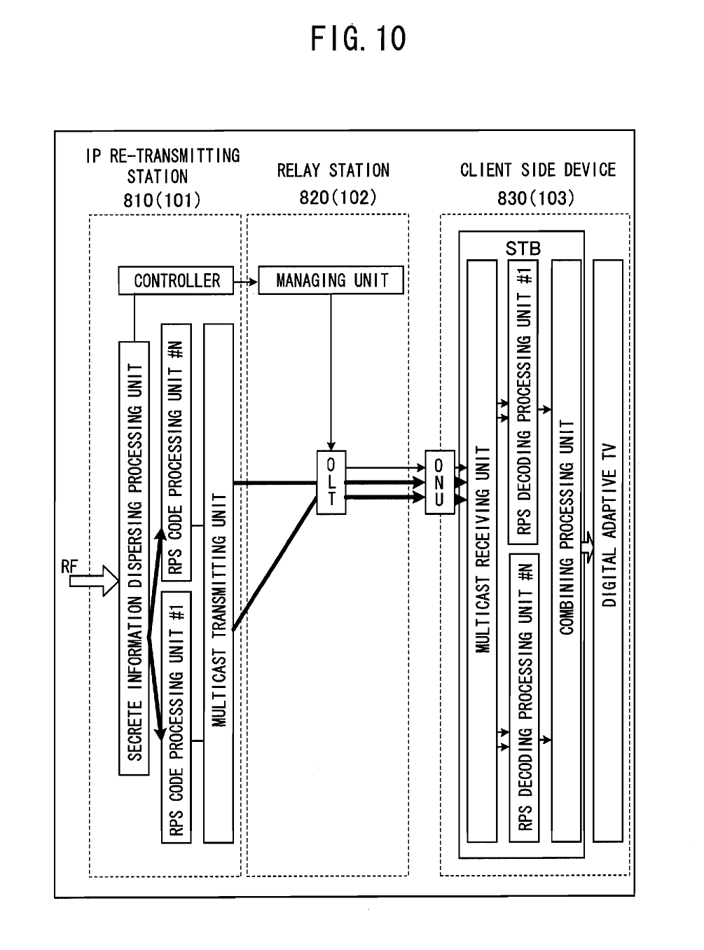

First, the detailed system construction of the communication system 100 in the embodiment 3 will be described. FIG. 10 is a diagram showing the detailed system construction of the communication system 100 in the embodiment 3. In FIG. 10, secrete information dispersing processing unit is a module of the IP re-transmitting station 810, and it divides a video content based on a digital terrestrial broadcast wave received by a broadcast antenna (not shown) into N parts. The RPS code processing units #1 to “N (only #1 and #N are shown in FIG. 10) are modules of the IP re-transmitting stations 810, and they are prepared in accordance with the division number #1 to #N.

A set top box STB is a module of the client side device 830, and it comprises a multicast receiving unit, RPS decoding processing units #1 to #N (only #1 and #N are shown in FIG. 10), and a combining processing unit. The RPS decoding processing units #1 to #N are prepared while paired with the RPS encoding processing units #1 to #N of the IP re-transmitting station 810. The combining processing unit combines the divisional data #1 to #N which are subjected to the RPS encoding processing by the RPS encoding processing units #1 to #N, thereby generating the original video content.

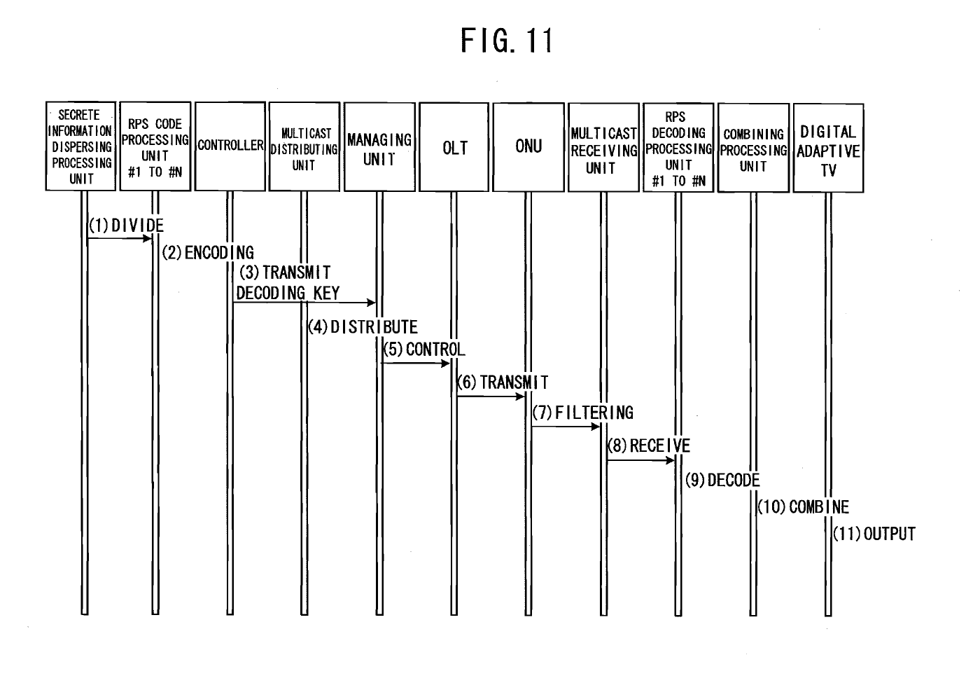

Next, the data communication processing of the embodiment 3 will be described. FIG. 11 is a sequence diagram showing the data communication processing in the embodiment 3, and shows a typical operation sequence concerning distribution of a video content. Numerals in parentheses represent the order of the sequence.

First, the video content based on the digital terrestrial broadcast wave received by the broadcast antenna is divided into N divisional data #1 to #N by the secret information dispersing processing unit (1). Subsequently, each of the divisional data #1 to #N is subjected to the RPS encoding processing by the RPS encoding processing units #1 to #N (2).

Thereafter, the controller transmits to the managing unit of the relation station 820 the decoding key data for decoding the divisional data #1 to #N which are subjected to the secrete information dispersing processing (3). Furthermore, the multicast distributing unit distributes to the client side device 830 the divisional data #1 to #N which are subjected to the RPS encoding processing (4).

Subsequently, OLT transmits the decoding key data to ONU under the control of the managing unit (5), relays the divisional data #1 to #N distributed from the IP re-transmitting station 810 and transmits them to the client side device 830 (6). ONU filters the divisional data #1 to #N and the decoding key data transmitted from OLT (7), and passes them therethrough when they are addressed to itself.

Subsequently, the multicast receiving unit receives the divisional data #1 to #N and the decoding key data which are filtered by ONU (8). Thereafter, the RPS decoding processing units #1 to #N decode the divisional data #1 to #N received by the multicast receiving unit (9).

The combining processing unit combines the divisional data #1 to #N decoded in the RPS decoding processing units #1 to #N on the basis of the decoding key data received by the multicast receiving unit (10), and finally the digital adaptive TV outputs the video content generated by the combining processing unit (11).

According to the embodiment 3, the video content is dispersively distributed, whereby the confidentiality of the video content can be implemented and the efficiency of the data transmission can be enhanced. Accordingly, the data communication speed can be increased, the stability and the communication quality can be enhanced, and the total cost of the communication system 100 can be reduced.

The scramble processing described in the embodiment 2 is applied to the dispersive data described in the embodiment 3, whereby the distribution of the video content for which confidentiality is more surely secured can be implemented. Here, an enciphering system for subjecting the dispersive data of the video content to the scramble processing will be described.

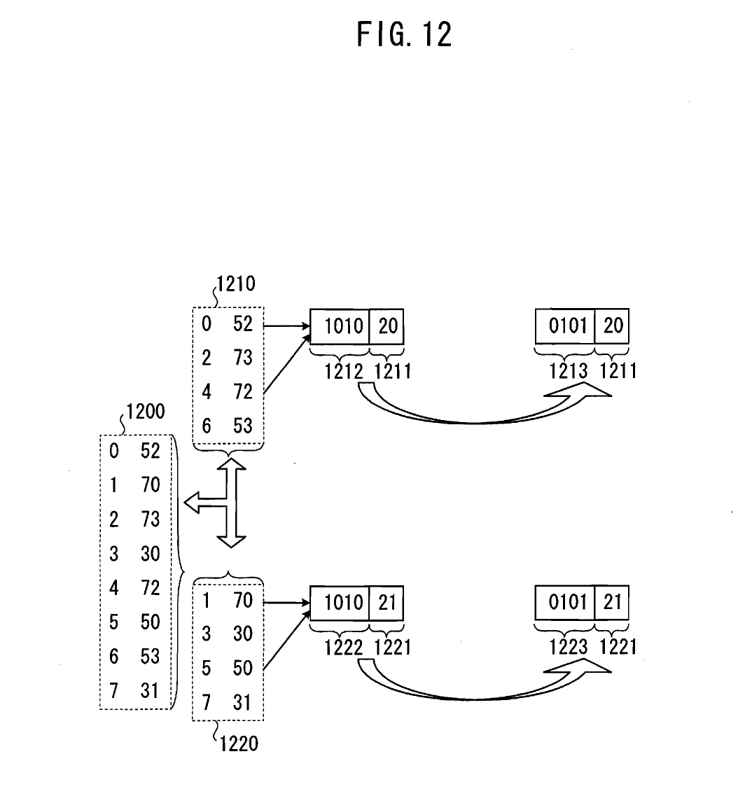

FIG. 12 is a diagram (part 2) showing an example of the enciphering system. In this case, the decoding key data in the information dispersive transmission based on the RPS code when the original data are [R(0x52), p(0x70), s(0x73), 0(0x30), r(0x72), P(0x70), S(0x73), 1 (0x31)] will be described.

In FIG. 12, dispersive data 1210 and dispersive data 1220 are generated by dispersing original data 1200. The data 1211 represents the exclusive OR (XOR) among the blocks [52, 73, 72, 53] of the dispersive data 1210, and the data 1212 is the header information of the dispersive data 1210. The data 1213 is the post-conversion header information after the scramble processing is executed on the data 1212.

Furthermore, the data 1221 represents the exclusive OR (XOR) among blocks [70, 30, 50, 31] of the dispersive data 1220, and the data 1222 is the header information of the dispersive data 1220. The data 1223 is the post-conversion header information after the scramble processing is executed on the data 1222. The decoding key data in this enciphering system becomes the scramble information representing the conversion table of the distribution information and the header information of the dispersive data 1210 and 1220.

According to this enciphering system, the video content is dispersed to the dispersive data 1210 and 1220, the header information of each of the dispersive data 1210 and 1220 is subjected to the scramble processing, and then these data are distributed, whereby the confidentiality of the video content can be enhanced.

As described above, according to the content distributing method, the relay node, the data communication program and the recording medium in which the program concerned is recorded, the content distribution service can be smoothly provided by constructing the communication system in which the area limitation and the confidentiality of the contents can be properly maintained.

The content distributing method described with respect to the above embodiments can be implemented by executing a prepared program through a computer such as a personal computer, a work station or the like. This program is recorded in a computer-readable recording medium such as a hard disk, a flexible disk, CD-ROM, MO, DVD or the like, and the program is read out from the recording medium and executed by the computer. Furthermore, this program may be a transmission medium which can be distributed through a network such as the Internet or the like.

Furthermore, the content distributing device 101, the relay node 102 and the information processing device 103 described in the above embodiments may be implemented by a standard cell, an application specific integrated circuit (hereinafter referred to as “ASIC”) such as a structured ASIC (Application Specific Integrated Circuit) or the like, or PLD (Programmable Logic Device) such as FPGA or the like. Specifically, the functional constructions 411 to 413, 421 to 424 and 431 to 433 of the content distributing device 101, the relay node 102 and the information processing device 103 are functionally defined by HDL descriptions, and the HDL descriptions are logically combined and supplied to ASIC or PLD, whereby the content distributing device 101, the relay node 102 and the information processing device 103 can be manufactured. In other words, the embodiments can be implemented in computing hardware and/or software. Further, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A content data distributing method, comprising:
first distributing enciphered content data from a higher distribution source through a relay node to a lower information processing device;
obtaining in the relay node a decoding key data contained in the content data for decoding, by the information processing device lower than the relay node concerned, the content data associated with a viewing/listening area managed by the relay node; and
second distributing by the relay node the obtained decoding key data to the information processing device lower than the relay node.

2. The content data distributing method according to claim 1, wherein the second distributing distributes the decoding key data to the lower information processing device than the relay node based upon information specifying the viewing/listening area and information identifying an information processing device existing in the viewing/listening area.

3. The content data distributing method according to claim 1, wherein the second distributing distributes the decoding key data to the lower information processing device than the relay node based upon information specifying a relay node group interposed between the relay node and an information processing device existing in the viewing/listening area.

4. The content data distributing method according to claim 1, wherein the second distribution distributes the decoding key data to the information processing device lower than the relay node before the content data associated with the viewing/listening area is relayed.

5. The content data distributing method according to claim 1, wherein when an enciphering key for enciphering the content data associated with the viewing/listening area is changed, the obtaining obtains decoding key data corresponding to the changed enciphering key.

6. The content data distributing method according to claim 1, wherein the first distributing encodes the content data using an error correcting code whose encoding rate is variable.

7. The content data distributing method according to claim 1, wherein the first distributing encodes the content data using RPS (Random Parity Stream) code.

8. A relay device comprising:
a transmission unit transmitting enciphered content data distributed from a higher distribution source to an information processing device lower than the relay device as a self node;
an obtaining unit obtaining decoding key data contained in the enciphered content data for decoding, in the lower information processing device than the self node, the content data associated with a viewing/listening area managed by the self node and; and
a distributing unit distributing the obtained decoding key data to the lower information processing device than the self node.

9. The relay device according to claim 8, wherein the distributing unit distributes the decoding key data to the lower information processing device than the relay node based upon information specifying the viewing/listening area and information identifying an information processing device existing in the viewing/listening area.

10. The relay device according to claim 8, wherein the distributing unit distributes the decoding key data to the lower information processing device than the relay node based upon information specifying a relay node group interposed between the relay node and the information processing device existing in the viewing/listening area.

11. The relay device according to claim 8, wherein the decoding key data is distributed to the lower information processing device than the relay node before the content data associated with the viewing/listening area is relayed.

12. The relay device according to claim 8, wherein when an enciphering key for enciphering the content data associated with the viewing/listening area is changed, the obtaining unit obtains the decoding key data corresponding to the changed enciphering key.

13. The relay device according to claim 8, wherein the content data distributed from the distribution source is encoded by using an error correction code whose encoding rate is variable.

14. A computer-readable recording medium storing a program for controlling a computer to execute a content data distributing operations comprising:
first distributing enciphered content data from a higher distribution source through a relay node to a lower information processing device;
obtaining in the relay node a decoding key data contained in the content data for decoding, by the information processing device lower than the relay node concerned, the content data associated with a viewing/listening area managed by the relay node; and
second distributing the relay node the obtained decoding key data to the lower information processing device.

15. The computer-readable recording medium according to claim 14, wherein the second distributing distributes the decoding key data to the lower information processing device than the relay node based upon information specifying the viewing/listening area and information identifying an information processing device existing in the viewing/listening area.

16. The computer-readable recording medium according to claim 14, wherein the second distributing distributes the decoding key data to the lower information processing device than the relay node based upon information specifying a relay node group interposed between the relay node and an information processing device existing in the viewing/listening area.

17. The computer-readable recording medium according to claim 14, wherein the second distributing distributes the decoding key data to the information processing device lower than the relay node before the content data associated with the viewing/listening area is relayed.

18. The computer-readable recording medium according to claim 14, wherein when an enciphering key for enciphering the content data associated with the viewing/listening area is changed, the obtaining obtains decoding key data corresponding to the changed enciphering key.

19. The computer-readable recording medium according to claim 14, wherein the first distributing encodes the content data using an error correcting code whose encoding rate is variable.

20. A relay device comprising:
a controller
managing a viewing/listening area of enciphered content data relayed to information devices lower than the relay device, and
obtaining decoding key data contained in the enciphered content data distributed from a higher distribution source for decoding, by one of the information processing devices lower than the relay device, the enciphered content data associated with the viewing/listening area managed by the relay node; and
a transceiver transmitting the decoding key data and relaying the enciphered content data to the lower information processing device.
